(19) United States
(12) Patent Application Publication
(10) Pub. No.: US 2015/0229621 A1
(43) Pub. Date: Aug. 13, 2015

(54) ONE-TIME-PAD DATA ENCRYPTION IN COMMUNICATION CHANNELS

(71) Applicant: Alexander Kariman, Rockville, MD (US)

(72) Inventors: Alexander V Kariman, Rockville, MD (US); Andrew V Bardachenko, Obuhov (UA)

(73) Assignee: SAFE FRONTIER LLC, McLean, VA (US)

(21) Appl. No.: 14/179,858

(22) Filed: Feb. 13, 2014

(51) Int. Cl. H04L 29/06

(52) U.S. Cl. CPC H04L 63/067; H04L 63/0428

(57) ABSTRACT

The present disclosure provides method and apparatus for protecting data transmitted in the communication channels between plurality of sender-devices and plurality of receiver-devices. The protection is achieved by using encryption with one-time-pad encryption keys, where such keys are distributed using one or more special media servers, and the protection of communications between such media server and plurality of devices is achieved using personal one-time-pad keys.

### FIELD OF THE INVENTION

This invention relates to methods of protecting digital information transmitted via a communication channel between plurality of sending and receiving devices, namely, using one-time-pad encryption that under certain conditions provides absolute cryptographic protection of the encrypted information.

### BACKGROUND

There are many known methods used for cryptographic data protection, whether the data is in-rest or in-flight. The method of protecting digital information disclosed herein uses One-Time-Pad encryption based on the Vernam cipher. Under certain conditions, this method features absolute cryptographic stability.

One-time-pad (OTP) was patented in 1919 (U.S. Pat. No. 1,310,719). Because it involves a random key character used to encrypt each character of plaintext, there is no information in the cipher-text on which to use cryptanalysis. The number of possible keys approaches infinity and even if some of them were guessed and operated on the cipher-text to produce meaningful plaintext, there would be no way to know which of the multitude of plaintexts rendered was the intended one.

Vernam cipher is the only known system that is mathematically proven to provide absolute cryptographic stability. E.g., intercepted encrypted data provides no information about the message. From the cryptography point of view, it is impossible to attain a system more secure than Vernam cipher. However, implementation of such system is not a trivial task, since it requires a truly random one-time-pad encryption key to be equal in size to the size of a message to be encrypted, followed by a guaranteed destruction of such key on the encrypting/decrypting device. Therefore, a commercial implementation of the Vernam cipher is very limited, unlike the use of public key-based and other common asymmetric and symmetric encryption systems.

Vernam cipher is one of the simplest and least demanding cyphers, which makes possible using such cypher on almost any electronic device. In order to generate a cipher-text, plain text (any digital data) is combined using “exclusive OR” (XOR) operation with an encryption key (called “one-time-pad” or “cipher-pad” or “gamma”). However, the key must demonstrate three critical properties:
1. Have uniformly random distribution;
2. Be equal in size with a message to be encrypted;
3. Be used only once.
   There is also a fourth, not so obvious requirement, where one-time-pad key must be destroyed immediately after use.

Vernam encryption is rarely used due to the fact that modern cryptography techniques are sufficiently developed. However, the technological advancement in crypto-analysis and increase of computing power increases the probability of successful attacks on sophisticated ciphers.

Modern storage media can now store large amount of random key data, and random number generators can produce sufficient quality random key material for use with a Vernam cipher. All these factors now make Vernam cipher a more attractive option.

As a practical matter, it is also possible to physically transfer a storage medium with sufficient amount of truly random key material necessary to encrypt messages. In fact, cipher-pads are based on this principle: a notepad containing pages with key material is transported via diplomatic mail or in person. The same notepad is present at a receiving side. Used pages are then destroyed.

In order for Vernam cipher to work, it requires a truly random encryption key. Encryption key material obtained using any mathematical algorithm is not truly random, but pseudo-random. Therefore, it is necessary to obtain a random sequence not algorithmically (for example, using white noise - radioactive decay, or other somewhat random events). In order to make the distribution fairly close to uniform, random sequence is typically processed using a hash function, such as MD5.

The disadvantage of using the Vernam cipher is the lack of authentication and message integrity. The recipient cannot verify if the message was modified or verify the authenticity of a sender. If a third party intercepts a message, knowing the message plain-text, it is possible to restore the one-time-pad key used to encrypt the message, and such party would be able to replace the original message with a spoofed message of the same length. One option is to use a hash function (check-sum). In one exemplary embodiment, a hash function may be computed from a plain-text, and its value is encrypted together with a message. If the message is changed, hash value will also change. Thus, even if an attacker obtains a cipher-pad, without knowledge of the hash algorithm, an attacker cannot use it to spoof a message.

A variety of OTP-based systems are known. For example, as described in the U.S. Pat. No. 8,467,533 B2 (Publication date Jun. 18, 2013), in essence there is a one-time-pad encryption system where encrypted one-time-pad keys can be distributed to users on physical media or via a computer network from a central server. Another disclosure, PCT/US Application No. 1999/014224 (Publication date Nov. 16, 2000) comprises of a method for generating an identical electronic one-time-pad at a first and second locations. Each location is provided an electronic device, said electronic devices containing identical tables of true random numbers. Another invention described in the U.S. Pat. No. 8,050,405 B2 (Publication date Nov. 1, 2011), in essence comprises of methods for securely communicating a message from a first terminal to a second terminal, and includes generating a keypad including a random sequence of bits having a length, encrypting the message at the first terminal using a bit string beginning at an offset in the keypad, and transmitting the encrypted message and an indicator of the offset to the second terminal. Another invention described in the U.S. Pat. No. 6,363,152 B1 (Publication date 26 Mar. 2002), in essence describes a hybrid one time pad encryption and decryption apparatus with methods for encrypting and decrypting data wherein a one-time random number pad provides high security encryption.

### SUMMARY

The present invention aims to resolve complications outlined above related to implementation of a one-time-pad encryption system; and therefore the invention is relevant in the light of increasing deciphering capabilities of modern computing systems.

### DESCRIPTION OF THE INVENTION

The following description and the referrals to the accompanying drawings show, by way of illustration, specific details and aspects of this disclosure in which the invention may be practiced. The word “exemplary” is used herein to mean “serving as an example, instance, or illustration”. Any aspect of this disclosure described herein is not necessarily to be construed as preferred or advantageous over other aspects of this disclosure or designs unless expressly stated. The term “circuit” (or “circuitry”) may be understood as any kind of logic implementing entity, which may be hardware (in some exemplary embodiment, including silicon), software, firmware, or any combination thereof. Thus, a “circuit” may be a hard-wired logic circuit or a programmable logic circuit such as a programmable processor, e.g. a microprocessor. A “circuit” may also be software being implemented or executed by a processor, e.g. any kind of computer program. Any other kind of implementation of the respective functions described herein may also be understood as a “circuit” or “circuitry”. The terms “coupling” or “connection” are intended to include a direct “coupling” or direct “connection” as well as an indirect “coupling” or indirect “connection” respectively. A “network” may be understood any physical and logical network, including Internet network, local network, wireless or wired network, etc. A “media server” may be understood as a server, a gateway, a proxy, a database, an electronic device, a device communicating over wired or wireless network, a device having electronic circuitry. A “device” or “electronic device” may be understood as any circuitry. A sender-device may be understood to be a circuitry that sends using a communications interface at least one data packet. A receiver-device may be understood to be a circuitry that receives using a communications interface at least one data packet. A “message” may be understood as at least one data packet sent or received using a communication interface of an electronic device. A “Random Number Generator (RNG)” may be understood to include software RNG, firmware RNG, hardware RNG, and any circuitry capable of generating a random or pseudorandom bit sequence. A “hash function” may be understood to include any algorithm that maps data of arbitrary length to data of a fixed length.

In one exemplary embodiment, one-time-pad key is used to encrypt data, where the data is the same size as the one-time-pad key. In another exemplary embodiment, such one-time-pad key is generated on a media server, where in another exemplary embodiment, such server is equipped with a special device—random number generator (RNG).

In another exemplary embodiment, one or more RNGs may be used that are capable of achieving random uniform distribution. In another exemplary embodiment, such RNG may be operably and/or communicatively coupled with a media server.

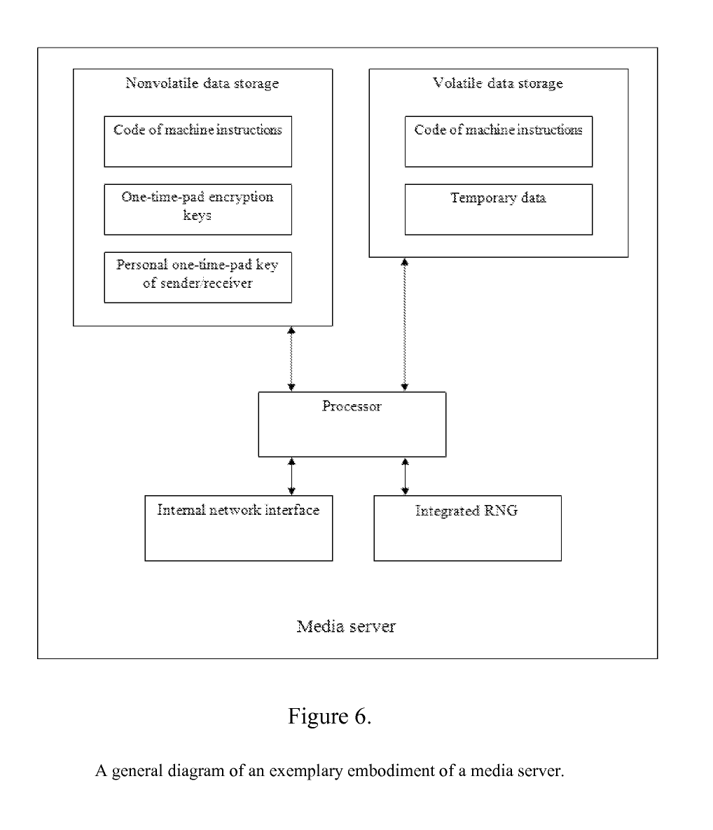

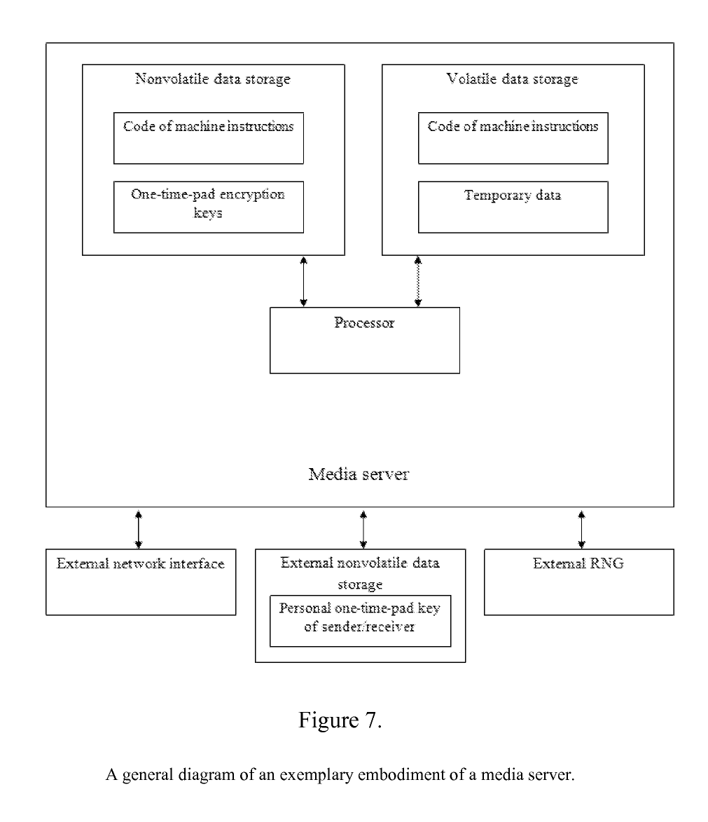

FIGS. 6 and 7, in one exemplary embodiment illustrate one of many possible implementations of a media server with operably and/or communicably coupled plurality of RNGs.

In one exemplary embodiment, a sender-device requests one-time-pad key from a media server prior to transmitting a data message to be encrypted, where the length of the one-time-pad key equals to the length of the encrypted data. In another exemplary embodiment, a media server uses an RNG to produce one-time-pad key of desired length, and sends such key to the message sender-device. In addition, the media server stores the generated one-time-pad key in a nonvolatile storage device (such as a hard-disk or a removable data storage media) in order for the receiver of the encrypted message (receiver-device) to be able to obtain from the media server this one-time-pad key to decrypt the received message. In another exemplary embodiment, in order to identify the specific one-time-pad key among others generated for different messages, each one-time-pad key is assigned a unique identifier. This identifier is transmitted together with a one-time-pad key to the sender-device that requested the one-time-pad key.

The communication channel between a sender-device and a media server can also be potentially intercepted; therefore, it must be protected as well. It is known, if one would apply to any one-time-pad key any encryption algorithm with a key having length that is less than the length of the one-time-pad key, the strength of the encryption method will equal to the strength of the encryption key of smaller length. Therefore, in order to protect one-time-pad keys transmitted between a media server and a device (message sender and message receiver), the same one-time-pad encryption system is used, complying with all four requirements of the one-time-pad system.

In one exemplary embodiment, a sender and a receiver may obtain a personal one-time-pad key, generated, in one exemplary embodiment, on a media server, and in one exemplary embodiment, stored in a nonvolatile memory of an electronic device. In another exemplary embodiment, such personal key may be stored in an external storage medium communicably coupled with an electronic device. In another exemplary embodiment, such private key is not only stored on an electronic device but also stored in the nonvolatile data storage operably and/or communicably coupled with a media server.

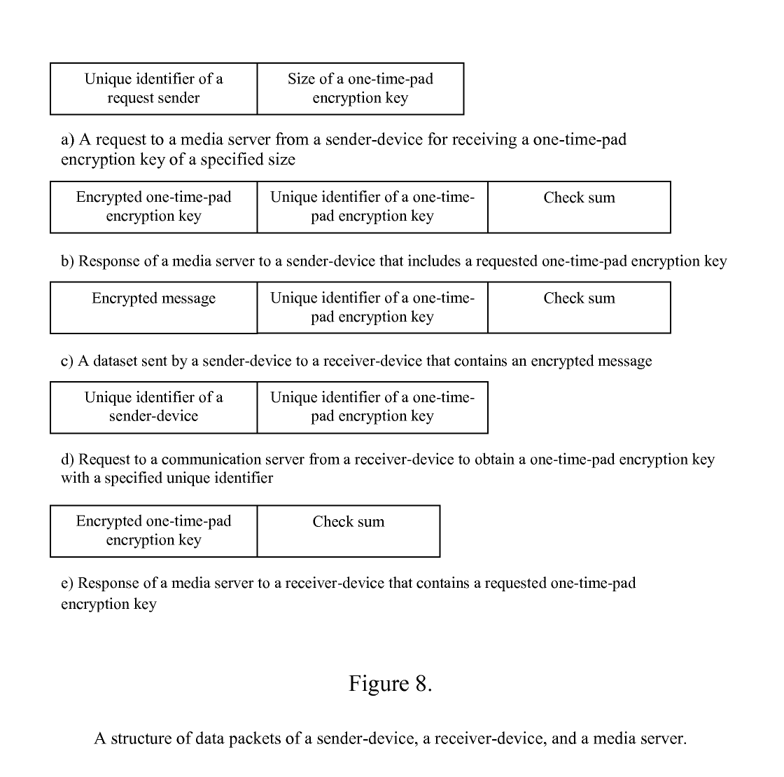

In one exemplary embodiment, each electronic device has a unique identifier within the system, and therefore, a media server can determine what personal one-time-pad key should be used for each electronic device. Therefore, when a device requests media server to provide a one-time-pad encryption key, it includes in the query a unique device identifier, in addition to specifying the size of the required one-time-pad encryption key (FIG. 8).

After the media server identifies the device, it can use personal one-time-pad key of such device for OTP encrypting of the one-time-pad encryption key to be transmitted to the device that requested such key. Since the size of the personal one-time-pad key stored on a media server and stored on a device is significantly larger than the size of the one-time-pad encryption key requested for a transaction, the media server can be providing such one-time-pad encryption keys for performing many transactions. In one exemplary embodiment, such transactions may be a part of encrypting streaming data communications, near-real-time video and audio communications, large file transfers, etc., between two or more electronic devices.

In another exemplary embodiment, after using a part of a personal one-time-pad key for encrypting a one-time-pad encryption key used to encrypt a message, the used part of the private one-time-pad key is destroyed on the media server and the electronic device. In another exemplary embodiment, such used part of a private one-time-pad key is destroyed in the volatile and nonvolatile memory of the electronic device and the media server. This ensures meeting the fourth one-time-pad system requirement (the destruction of a one-time-pad encryption key immediately after use).

In one exemplary embodiment, after receiving a one-time-pad encryption key from a media server, a software coupled with a message sender-device, and where such software having an unencrypted message and a one-time-pad encryption key of the same size as the message, may perform a bit-wise XOR operation between an unencrypted message and a one-time-pad encryption key, e.g., essentially encrypting the message using Vernam cipher. In another exemplary embodiment, such software may be residing in an electronic device hardware, firmware, and/or software. Given that the length of an unencrypted message equals to the length of the one-time-pad encryption key, which is obtained from a media server, the second requirement of the one-time-pad encryption system is also met.

In order to monitor integrity of the transmitted encrypted messages, in one exemplary embodiment, a check-sum calculation may be performed prior to encrypting a message (FIG. 8) Thus, if the message is spoofed, the check-sum calculated after the message is decrypted will be incorrect and the recipient will know that the message did not come from the anticipated sender. In another exemplary embodiment, the same method is used for monitoring a message integrity that is transmitted between a media server and a sender and/or receiver device, e.g., a message containing a one-time-pad encryption key (FIG. 8).

In one exemplary embodiment, after successfully sending a message to a recipient, a sender-device destroys the used one-time-pad encryption key stored in the nonvolatile and/or volatile memory. Analogous to the destroying a used personal one-time-pad key, this operation ensures meeting the fourth one-time-pad system requirement (destruction of one-time-pad key immediately after use).

In another exemplary embodiment, when a receiver-device gets an encrypted message, it follows virtually similar steps as a sender-device to process the message; where, in one exemplary embodiment, the same device can be both a sender-device and a receiver-device of plurality of encrypted messages originating from various sources, and no modification to the device design is required. In one exemplary embodiment, a receiver-device derives from a received message a unique identifier of the one-time-pad encryption key (FIG. 8). Next, the receiver-device makes a request to a media server to obtain a one-time-pad encryption key, specifying a unique identifier of such key. In this query, as in the case with the sender-device, a unique identifier of the receiver-device is also transmitted. The media server, similar to the procedure described earlier with the sender-device, identifies the receiver-device using a unique identifier of such device that is also transmitted in the message. The media server then retrieves, using such identifier, from a nonvolatile memory, which is used for storing one-time-pad encryption keys, a required one-time-pad encryption key. Next, the media server determines the length of the one-time-pad encryption key required and retrieves from a nonvolatile memory, a part of a personal one-time-pad key equal in length to the length of the one-time-pad encryption key. Further, the media server executes XOR encryption of the one-time-pad encryption key, using the personal one-time-pad key of the receiver-device that requested such one-time-pad encryption key.

In another exemplary embodiment, in order to ensure integrity of a response message, a media server calculates a check-sum of a one-time-pad key while it is unencrypted, and transmits it in the response together with a message containing the encrypted one-time-pad encryption key. The receiver-device, receives a message from the media server, extracts the check-sum and the one-time-pad encryption key. Next, the receiver-device retrieves from its nonvolatile memory, used to store a personal one-time-pad key, a part of a personal one-time-pad key that is the same size as the size of the encrypted one-time-pad encryption key. Next, the receiver-device executes an XOR operation on a received encrypted one-time-pad encryption key, using a part of the personal one-time-pad key, thereby obtaining as a result of such operation an unencrypted one-time-pad encryption key transmitted by the media server.

Next, the receiver-device verifies a check-sum of the one-time-pad encryption key received from a media server using a hash function. A hash function is applied to an unencrypted one-time-pad key and then the result is compared with a check-sum received in the message. If the check-sums match, the device that received a message concludes that the received message is indeed sent by media server.

Next, the receiver-device destroys a used part of a private one-time-pad key, thereby fulfilling the fourth requirement of the one-time-pad encryption system (distraction of used one-time-pad keys).

Next, the receiver-device performs XOR operation on an encrypted message received from a sender-device using the decrypted one-time-pad encryption key received from a media server. Further, the device calculates and compares a check-sum of the received message, similar to a check-sum operation described earlier in connection with a media server. If a check-sum of the decrypted message matches the check-sum transmitted by the message sender-device, the receiver-device concludes that the message is sent by the anticipated sender and has not been modified in the communication channel. After a successfully message decryption, the receiver-device destroys a used one-time-pad encryption key received from a media server.

Thus, all parts of the system meet all four requirements of the OTP encryption.

It should be noted that for proper execution of the fourth requirement (removal of used keys), hardware and software-based methods may be used that guarantee information destruction in nonvolatile and/or volatile memory of the electronic device and/or all coupled data storage devices.

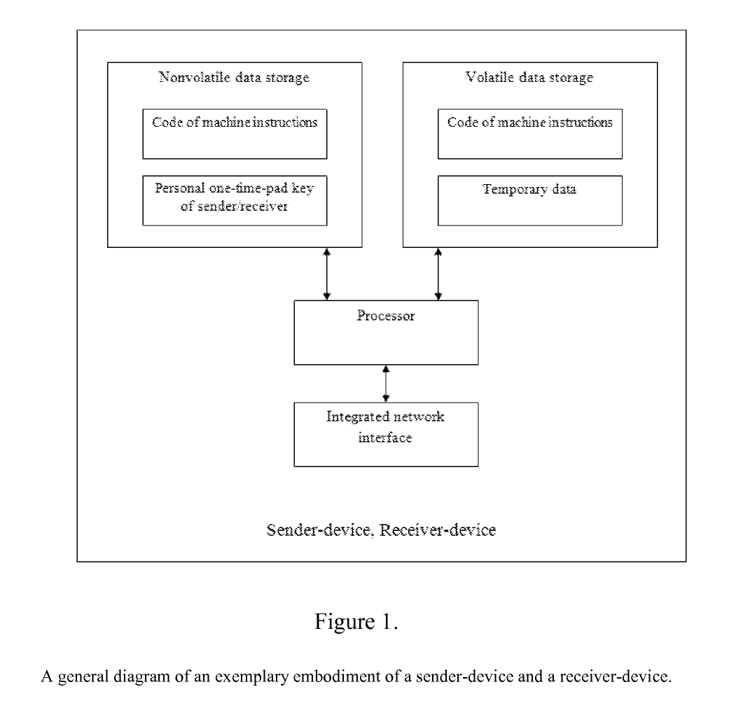

FIG. 1-5 illustrates some exemplary embodiments of sender and receiver devices.

FIG. 1 illustrates in one exemplary embodiment an integrated solution, where all the relevant components of the OTP system are located inside a device enclosure. In another exemplary embodiment, system components may be located in a device circuitry.

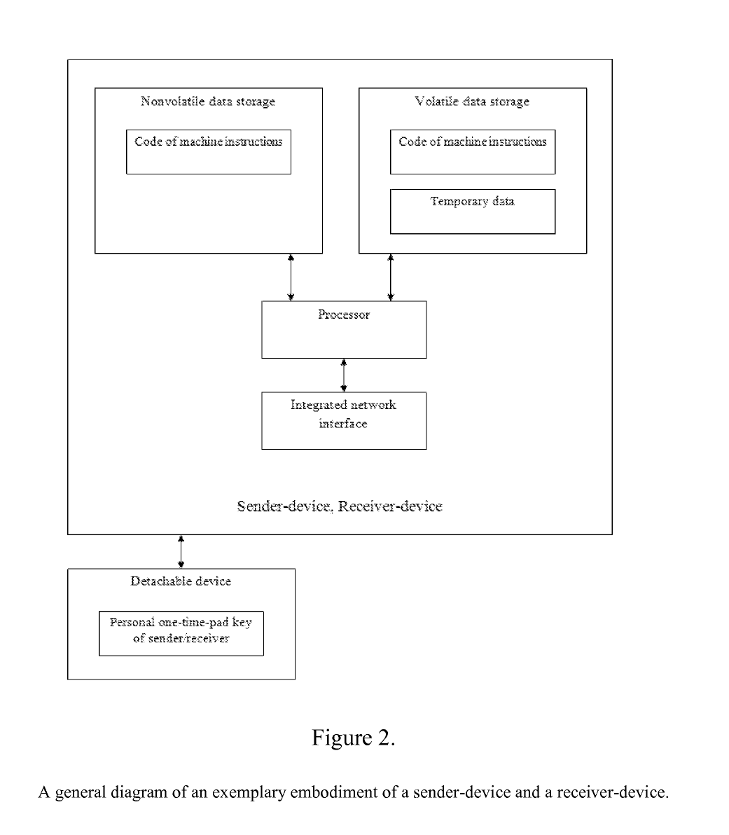

FIG. 2 illustrates in one exemplary embodiment, where a detachable device can be utilized to store a personal one-time-pad key. In this case, as long as the device user does not connect a detachable device that stores a personal one-time-pad key, the message cannot be decrypted. Also, this method is applicable when a user employs multiple electronic devices. A user can send and receive messages from different devices by connecting a detachable device containing personal one-time-pad key to various sender/receiver devices. In one exemplary embodiment, such devices could be a personal computer, a tablet, a smart phone, an embedded device, a hand-held device coupled with a radio module, a concealed device, a device having an electronic circuitry, and the like. Also, this method allows a user to delegate powers to another user, by providing the other user with a detachable device containing a personal one-time-pad key.

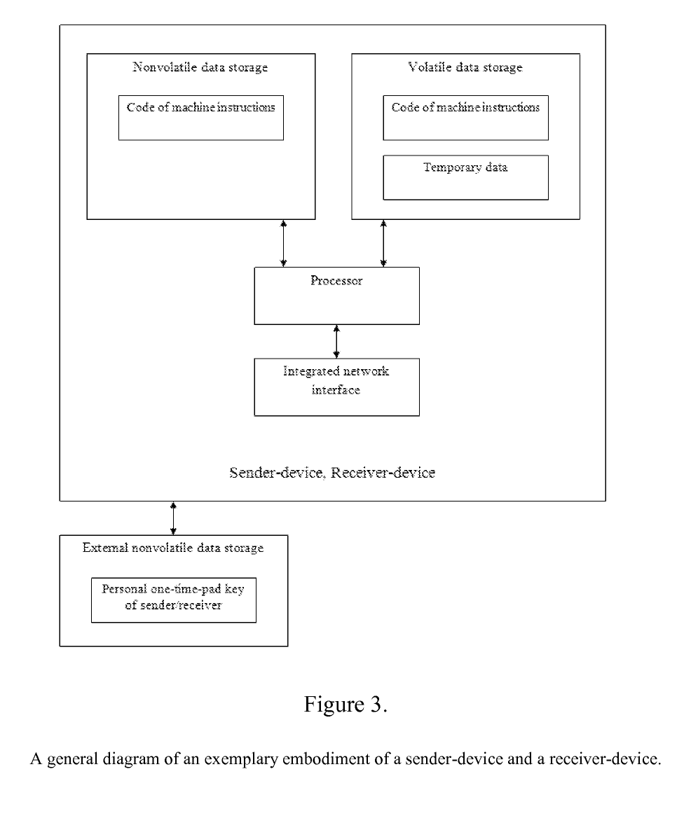

FIG. 3 illustrates in one exemplary embodiment, a device with a connected external data storage, such as an external hard-drive. This method can be used to store very large private one-time-pad keys. Also, this approach allows decentralization, where in case of theft, there are two devices would be required to decrypt a message—the receiver/sender device itself and a detachable personal one-time-pad key storage device.

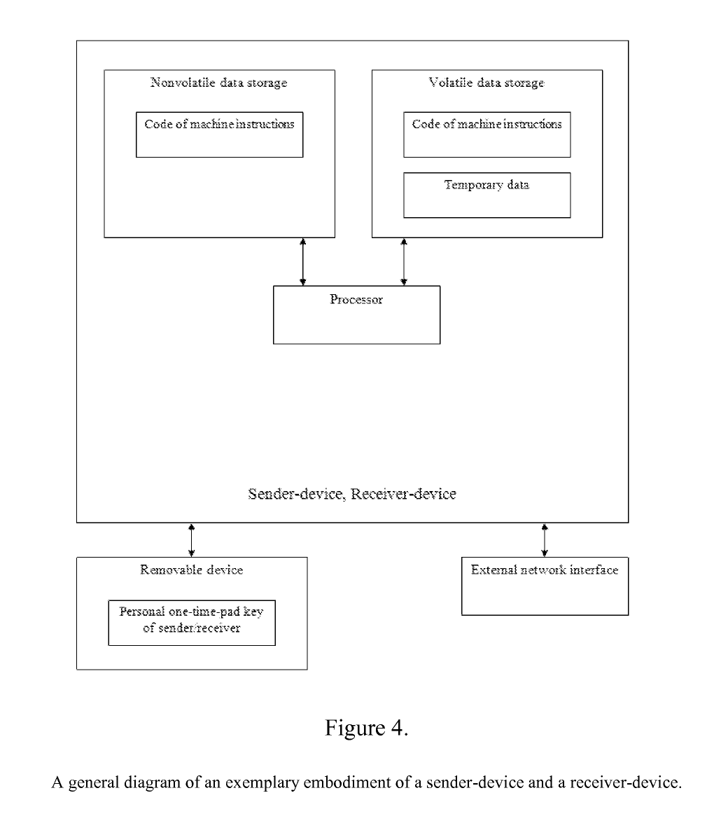

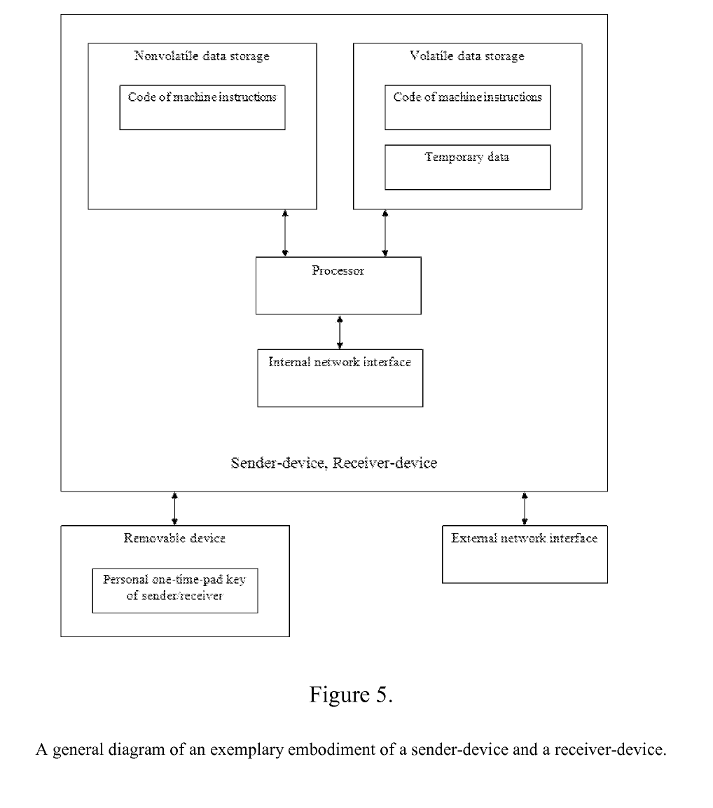

FIG. 4 illustrates an exemplary embodiment of a device communicatively coupled with an external network device. For example, an external WiFi network card that can be connected to the device, and/or a GSM, and/or other transceiver, wherein the device can communicate with a media server and/or other devices via one or more available network interfaces. FIG. 5 illustrates an exemplary embodiment of a device, having internal communication interface and communicatively coupled with an external network device. Either or both network interfaces can be used to transmit messages. FIG. 6 illustrates an exemplary embodiment of a media server operably coupled with an integrated network interface and an integrated RNG. FIG. 7 illustrates an exemplary embodiment of a media server communicatively coupled with an external network interface, an external RNG, and external nonvolatile data storage for storing personal one time pad keys of sender and receiver. FIG. 8 illustrates a structure of data packets of a sender-device, a receiver-device, and a media server.

In another exemplary embodiment, the described herein methods and apparatuses can be utilized to enable OTP encrypted communication between multiple sender/receiver devices, such as enabling OTP encrypted video/audio conferencing, email exchange, file exchange, standard multi-party digitized telephone voice communications, etc. In such case, a personal one-time-pad encryption key is not destroyed on a media server. In another exemplary embodiment, such methods and apparatuses can be used to exchange messages utilizing push and pull network communication technologies, including but not limited to unicasting, multicasting, and broadcasting messages, such as SMS, Instant Messages, and the like. In another exemplary embodiment, such communication may be enabled via wired and wireless networks and via any number and any kind of gateways and proxies. In another exemplary embodiment, there could be any number of media servers and they can be geographically distributed. In another exemplary embodiment, any type of communication channel may be encrypted using the disclosed herein methods and apparatuses, e.g., end-to-end communication tunnels, publish/subscribe protocols-based communications, TCP/UDP-based communications, as well as non-TCP communications. The disclosed herein encryption methods can also be used in addition to any other data protection technology, such as TLS/SSL and the like.

The present invention allows implementing one-time-pad data encryption in the communication channels, using a media server for storing and exchanging one-time-pad encryption keys, where such system confirms to all OTP encryption system characteristics:
1. One-time-pad keys have uniformly random distribution;
2. One-time-pad keys are the same size as the data to be encrypted;
3. One-time-pad keys are used only once;
4. One-time-pad keys are destroyed after use.

Of course, many exemplary variations may be practiced with regard to establishing such interaction. The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilized for realizing the invention in diverse forms thereof

While various embodiments of the present invention have been described above, it should be understood that they have been presented by way of example only, and not limitation. It will be understood by those skilled in the art that various changes in form and details may be made therein without departing from the spirit and scope of the invention as defined in the appended claims. Thus, the breadth and scope of the present invention should not be limited by any of the above-described exemplary embodiments, but should be defined in accordance with the following claims and their equivalents.

What claimed is:

1. Electronic device capable of sending and/or receiving data that includes:
(a) at least one data storing medium for storing at least one bit of a personal one-time-pad key; and
(b) at least one data storing medium for storing at least one bit of a one-time-pad encryption key; and
(c) at least one data storing medium for storing a code of machine instructions; and
(d) at least one processor capable of executing a code of machine instructions; and
(e) at least one network interface capable of communicating with one or more media servers; and
(f) at least one network interface capable of sending and/or receiving data to/from one or more electronic devices; and
(g) code of machine instructions that is capable of
sending data to at least one media server and/or receiving data from at least one media server, and where such data includes a one-time-pad encryption key that is encrypted using a part of a personal one-time-pad key; and
encrypting and/or decrypting data using a one-time-pad encryption key received from a media server; and
sending data to one or more electronic devices and/or receiving data from one or more electronic devices; and
destroying one-time-pad keys.

2. Apparatus according to claim 1, wherein at least one bit of a personal one-time-pad key is stored in one or more nonvolatile and/or volatile data storage devices, where such device is at least one of: operably coupled with an electronic device, and communicatively coupled with an electronic device, and detachable from an electronic device, and is the same data storage device, where a code of machine instructions is stored.

3. Apparatus according to claim 1, wherein an electronic device has at least one network interface module capable of communicating with at least one media server and/or at least one electronic device and such module is at least one of: operably coupled with an electronic device, and communicatively coupled with an electronic device, and detachable from an electronic device.

4. A media server that includes:
(a) at least one data storing medium for storing a set of personal one-time-pad keys of plurality of electronic devices that send data (sender-device), and/or plurality of electronic devices that receive data (receiver-device); and
(b) at least one data storing medium for storing a set of one-time-pad encryption keys; and
(c) at least one data storing medium for storing a code of machine instructions; and
(d) at least one processor capable of executing a code of machine instructions; and
(e) at least one network interface capable of communicating with one or more sender-devices and/or one or more receiver-devices; and
(f) code of machine instructions that is capable of
receiving data from at least one sender-device and/or at least one receiver-device that includes a request for sending a one-time-pad encryption key; and
sending data to at least one sender-device and/or at least one receiver-device where such data includes one-time-pad encryption key which is encrypted using a part of a personal one-time-pad key of such sender-device and/or such receiver device; and
destroying one-time-pad keys.

5. Apparatus according to claim 4, wherein at least one bit of a personal one-time-pad key of one or more sender-devices and/or one or more receiver-devices is stored in at least one nonvolatile and/or volatile data storage device, where such device is at least one of: operably coupled with a media server, and communicatively coupled with a media server, and detachable from a media server, and is the same data storage device, where a code of machine instructions is stored.

6. Apparatus according to claim 4, wherein at least one bit of a one-time-pad encryption key is stored in at least one nonvolatile and/or volatile data storage device, where such device is at least one of: operably coupled with a media server, and communicatively coupled with a media server, and detachable from a media server, and is the same data storage device, where a code of machine instructions is stored.

7. Apparatus according to claim 4, wherein at least one bit of a one-time-pad encryption key is generated using an RNG, where such RNG is at least one of: operably coupled with a media server, and communicatively coupled with a media server, and detachable from a media server.

8. Apparatus according to claim 4, wherein a media server has a network interface module capable of communicating with one or more sender-devices and/or one or more receiver-devices, and such module is at least one of: operably coupled with a media server, and communicatively coupled with a media server, and detachable from a media server.

9. Method comprising of a code instruction coupled with a sender-device, including the following steps:
(a) determining a size of data to be transmitted (message) to a receiver-device; and
(b) sending data to a media server that includes a request to provide a one-time-pad encryption key, where such one-time-pad encryption key is the same size as the message, and such request contains an identifier of a sender-device; and
(c) receiving data from a media server containing an encrypted one-time-pad encryption key, where such one-time-pad encryption key equals in size to a message, and receiving an identifier of such one-time-pad encryption key; and
(d) decrypting the received one-time-pad encryption key using bitwise XOR operation applied to each bit of the one-time-pad encryption key, wherein the second operand is the appropriate consecutive bit (starting the first bit) of a personal one-time-pad key of a sender-device; and
(e) destroying a used part of a personal one-time-pad key that was used for decrypting the one-time-pad encryption key received from a media server, and where the size of such part of a personal one-time-pad key equals to the size of the one-time-pad encryption key; and
(f) encrypting a message using bitwise XOR operation, wherein the second operand is the appropriate consecutive bit (starting the first bit) of a decrypted one-time-pad encryption key received from a media server; and
(g) destroying a used one-time-pad encryption key received from a media server; and
(h) sending data to at least one receiver-device where such data contains an encrypted message and an identifier of a one-time-pad encryption key that was used to encrypt a message.

10. Method according to claim 9, wherein a response of a media server contains a check-sum value, where such check-sum value is a result of executing a hash function, wherein one of the arguments is a data sequence consisting of a decrypted one-time-pad encryption key and its identifier.

11. Method according to claim 9, wherein after decrypting a one-time-pad encryption key received from a media server, the integrity check is performed by comparing a check-sum value received from a media server and a result of executing a hash function, wherein one of the arguments is a data sequence consisting of a decrypted one-time-pad encryption key and its identifier.

12. Method according to claim 9, wherein before encrypting a message a check-sum is calculated using a hash function, wherein one of the arguments is a data sequence consisting of an unencrypted message and an identifier of a one-time-pad encryption key used to encrypt a message.

13. Method according to claim 9, wherein data transmitted to a receiver-device contains a check-sum value that is a result of executing a hash function, wherein one of the arguments is a data sequence consisting of an unencrypted message and an identifier of a one-time-pad encryption key used to encrypt a message.

14. Method comprising of a code of machine instructions coupled with a receiver-device, including the following steps:
(a) receiving data from one or more sender-devices containing an encrypted message and an identifier of a one-time-pad encryption key used to encrypt a message; and
(b) sending data to a media server that includes a receiver-device identifier and an identifier of a one-time-pad encryption key received as part of the transmitted data from at least one sender-device; and
(c) receiving data from a media server containing an encrypted one-time-pad encryption key; and
(d) decrypting a received one-time-pad encryption key using bitwise XOR operation applied to each bit of the one-time-pad encryption key, wherein the second operand is the appropriate consecutive bit (starting the first bit) of a personal one-time-pad key of a receiver-device; and
(e) decrypting a message received from at least one sender-device using bitwise XOR operation, wherein the second operand is the appropriate consecutive bit (starting the first bit) of a decrypted one-time-pad encryption key received from a media server; and
(f) destroying a used one-time-pad encryption key received from a media server; and
(g) destroying a used part of a personal one-time-pad key of a receiver-device that was used to decrypt a one-time-pad encryption key received from a media server, and where such used part of a personal one-time-pad encryption key is equal in size to the one-time-pad encryption key received from a media server.

15. Method according to claim 14, wherein data received from at least one sender-device contains a check-sum value, where such check-sum value is a result of executing a hash function, wherein one of the arguments is a data sequence consisting of a decrypted message and a one-time-pad encryption key identifier used to encrypt a message.

16. Method according to claim 14, wherein data received from a media server contains a response that includes a check-sum value that is a result of executing a hash function, wherein one of the arguments is a data sequence consisting of an unencrypted one-time-pad encryption key.

17. Method according to claim 14, wherein after decrypting a one-time-pad encryption key received from a media server, the integrity check is performed by comparing a check-sum value received from a media server and a result of executing a hash function, wherein one of the arguments is a data sequence consisting of a decrypted one-time-pad encryption key and its identifier.

18. Method according to claim 14, wherein after decrypting a message received from a sender-device, the integrity check is performed by comparing a check-sum value received from a sender-device and a result of executing a hash function, wherein one of the arguments is a data sequence consisting of a decrypted message and an identifier of a one-time-pad encryption key used to encrypt a message.

19. Method comprising of a code of machine instructions coupled with a media server for communicating with one or more sender-devices, includes the following steps:
(a) receiving data from one or more sender-devices containing a request for a one-time-pad encryption key of a specified size and an identifier of a sender-device; and
(b) identifying a sender-device using an identifier received in the request; and
(c) generating a one-time-pad encryption key of the size specified in the request; and
(d) assigning an identifier to such generated one-time-pad encryption key and saving such one-time-pad encryption key in at least one data storage medium; and
(e) obtaining from a data storage medium, a part of a personal one-time-pad key of a sender-device, where such part of a personal one-time-pad key equals in size to the size specified in the request; and
(f) encrypting at least one bit of a generated one-time-pad key using bitwise XOR operation, wherein the second operand is the appropriate consecutive bit (starting the first bit) of a part of a personal one-time-pad key of a sender-device; and
(g) transmitting data to a sender-device that includes an encrypted one-time-pad encryption key, where such one-time-pad encryption key is the same size as the size specified in the request, and transmitting an identifier of such one-time-pad encryption key; and
(h) destroying a used part of a personal one-time-pad key of a sender-device, where such used part of a personal one-time-pad key is the same size as the size specified in the request.

20. Method according to claim 19, wherein prior to encrypting one-time-pad encryption key a check-sum value is calculated, where such check-sum value is a result of executing a hash function, wherein one of the arguments is a data sequence consisting of a decrypted one-time-pad key and its identifier.

21. Method according to claim 19, wherein a media server transmits data to a sender-device that includes a check-sum value, where such check-sum value is a result of executing a hash function, wherein one of the arguments is a data sequence consisting of a decrypted one-time-pad encryption key and its identifier.

22. Method according to claim 19, wherein at least one bit of one-time-pad encryption key is generated using an RNG where such RNG is at least one of: operably coupled with a media server, and communicatively coupled with a media server, and detachable from a media server.

23. Method comprising of a code of machine instructions coupled with a media server for communicating with one or more receiver-devices, includes the following steps:
(a) receiving data from one or more receiver-devices containing a request for a one-time-pad encryption key, where such request includes an identifier of a receiver-device, and an identifier of a requested one-time-pad encryption key; and
(b) identifying a receiver-device using a receiver-device identifier received in a request; and
(c) obtaining from one or more data storage medium a one-time-pad encryption key, using a received identifier of a requested one-time-pad encryption key; and
(d) obtaining from a data storage medium, a part of a personal one-time-pad key of a receiver-device, where such part of a personal one-time-pad key equals in size to the size of a requested one-time-pad encryption key; and
(e) encrypting such one-time-pad encryption key using bitwise XOR operation, wherein the second operand is the appropriate consecutive bit (starting the first bit) of a part of a personal one-time-pad key of the receiver-device; and
(f) transmitting data to one or more receiver-devices that includes an encrypted one-time-pad encryption key; and
(g) destroying a used part of a personal one-time-pad key of a receiver-device, where such used part of a personal one-time-pad key equals in size to the size of a requested one-time-pad encryption key; and
(h) destroying a transmitted one-time-pad encryption key.

24. Method according to claim 23, wherein prior to encrypting at least one bit of a one-time-pad encryption key, a check-sum value is calculated, where such check-sum is a result of executing a hash function, wherein one of the arguments is a data sequence consisting of a decrypted one-time-pad encryption key.

25. Method according to claim 23, wherein a media server transmits data to a sender-device that includes a check-sum value, where such check-sum value is a result of executing a hash function, wherein one of the arguments is a data sequence consisting of a decrypted one-time-pad encryption key.

26. Method according to claim 23, wherein at least one bit of a one-time-pad encryption key and/or a personal one-time-pad key is generated using an RNG, where such RNG is at least one of: operably coupled with a media server, and communicatively coupled with a media server, and detachable from a media server.

27. Method according to claim 23, wherein a transmitted one-time-pad encryption key is not destroyed.
